SEQUENCE LISTING (1 sequence)

SEQ ID NO: 1 - protein, 10 aa, Epstein Barr virus
SSCSSCPLSK

(19) United States
(12) Patent Application Publication
(10) Pub. No.: US 2012/0196302 A1
(43) Pub. Date: Aug. 2, 2012

(54) DETECTING METHOD

(76) Inventors: Lee Jene LAI, Hsinchu (TW); Yi Heui HSIEH, Hsinchu (TW); Shih Jen LIU, Miaoli County (TW); Hsin Wei Chen, Miaoli County (TW)

(21) Appl. No.: 13/372,387

(22) Filed: Feb. 13, 2012

Related U.S. Application Data
(63) Continuation-in-part of application No. 12/272,130, filed on Nov. 17, 2008.

(30) Foreign Application Priority Data
Oct. 7, 2008 (TW) 097138557

(51) Int. Cl. G01N 21/64; B82Y 15/00

(52) U.S. Cl. 435/7.24; 435/7.21; 977/774; 977/902

(57) ABSTRACT

A detecting method is herein disclosed. The method includes steps of providing an eukaryotic cell, having a cell nucleus and a cell membrane, wherein the cell nucleus endogenetically translates a first receptor and a second receptor, and wherein the first receptor and the second receptor pass through the cell nucleus and translocate to the cell membrane; coupling the first receptor to a first bioactive ligand with a quantum dot; washing the cell coupled with the first bioactive ligand and the quantum dot by centrifugation; coupling the second receptor to a second bioactive ligand with a magnetic bead; washing the cell coupled with the first bioactive ligand and the second bioactive ligand by magnetic separation; irradiating a exciting energy for the quantum dot to emit a fluorescence, wherein the quantum dot coupled with the cell is excited in a pH range from pH 9 to pH 14; and detecting the fluorescence.

This present application is a continuation-in-part application of U.S. patent application Ser. No. 12/272,130, filed on Nov. 17, 2008.

### BACKGROUND OF THE INVENTION

1. Technical Field

The present invention relates to a detecting method, more particularly to a cell detecting method using a magnetic bead, a quantum dot and a quantum dot measuring system with a photomultiplier tube.

2. Background

Many diseases are caused by pathologic cells. For example, the mad cow disease is a neuronal pathology caused by abnormally folded prion, infective to different animals and incurable for now. A cervical cancer is caused by pathologic epidermal cells in cervix uterus. The number of pathologic cells is little in early stage; therefore, it is very important to improve the sensitivity and detection time for specific cells detection in the presence of trace pathologic cells.

The most commonly practiced methods in specific cell detection include immunofluorescence analysis and flow cytometry for now. The immunofluorescence analysis includes staining and then performing microscopic examination and counting with fluorescence microscope. Therefore, the immunofluorescence analysis includes the drawback of being time-consuming, labor-consuming and error-prone.

A flow cytometer is likely unable to analyze low amount of specific cells (less than 0.01%), due to the low signal to noise ratio. Therefore, it is necessary to perform cell culture to increase the cell amount for flow cytometry. It takes a lot of time for cell culture, and the cell detection is thus unable to be performed in a time-effective manner. In addition, most of the fluorescent markers used in the above-mentioned specific cell detection methods are organic fluorescent markers which rapidly decay when illuminated with ultraviolet light and cause the difficulty in counting cells.

In sight of the drawbacks of organic fluorescent markers, fluorescence markers of high fluorescence and stability have been researched by scientists. An inorganic quantum dot is first reported in 1998 to couple to cells or protein molecules with 20 folds greater in luminance in fluorescence microscope compared to the organic fluorescent markers.

Specific cells usually exist in the mixture of cells and are not easily specifically detected. Therefore, it is necessary to couple the inorganic quantum dot to the specific cells and isolate specific cells with the inorganic quantum dot from the mixture of cells.

Methods for isolating cells include centrifuge, column chromatography, flow cytometry and magnetic bead isolation. The magnetic bead isolation takes advantage of magnetism; that is to say magnetic beads are attracted in a magnetic field and are free and mobile in a non-magnetic field. A specific antibody is connected to the surface of a magnetic bead and then couples to the antigen on the surface of the cell for specific cells. The specific cell, which is connected to the surface of the magnetic bead, is isolated under the magnet. Magnetic bead isolation includes advantages of high specificity, simple operation and low cost by coupling of antibody and antigen.

Su et al (Anal. Chem. 76, 4806, 2004) adopted a quantum dot coupled with immuno-magnetic separation for detection of Salmonella and Escherichia coli O157:H7. However, the detecting sensor for Su et al adopted is a CCD (Charge-coupled device) which has limitation in detection sensitivity. In addition, bacteria are likely to form colonies and pathological cells in human bodies, which are shedding cells; therefore, the sensitivity requirement for detecting pathological cells is higher than detecting bacteria colonies.

To sum up, it is now a current goal to adopt a magnetic bead and quantum dot to achieve specific cell detection of high sensitivity without performing cell culture.

### SUMMARY

A cell detecting system is provided to use a magnetic bead, a quantum dot and a quantum dot measuring system with a photomultiplier tube and to achieve the goal of specific cell detection with high sensitivity without performing cell incubation.

A quantum dot measuring system is provided to use a photomultiplier tube and to achieve quantum dot measuring with high sensitivity.

In one embodiment, the proposed cell detecting system includes a quantum dot; a first bioactive ligand coupling to the quantum dot, wherein the first bioactive ligand recognizes and couples to a first receptor of a cell; a magnetic bead; a second bioactive ligand coupling to the magnetic bead, wherein the second bioactive ligand recognizes and couples to a second receptor of the cell, and a complex is formed with the first bioactive ligand, the quantum dot, the second bioactive ligand, the magnetic bead and the cell; a magnet configured for attracting the complex; and a quantum dot measuring system including an excitation light source configured for providing an exciting energy for the quantum dot of the complex to emit fluorescence; a detecting sensor configured for detecting the fluorescence, wherein the detecting sensor includes a photomultiplier tube converting the fluorescence into a signal; an optical system relaying the fluorescence to the detecting sensor; and a data capturing unit electrically connected to the detecting sensor and capturing the signal.

In another embodiment, the proposed quantum dot measuring system includes an excitation light source, a detecting sensor, an optical system, and a data capturing unit. The excitation light source is configured for providing an exciting energy for a quantum dot to emit fluorescence; the detecting sensor configured for detecting the fluorescence, wherein the detecting sensor comprises a photomultiplier tube converting the fluorescence into a signal; the optical system relays the fluorescence to the detecting sensor; and the data capturing unit electrically connected to the detecting sensor and capturing the signal.

Other advantages of the present invention will become apparent from the following description taken in conjunction with the accompanying drawings wherein are set forth, by way of illustration and example, certain embodiments of the present invention.

The present invention provides a cell detecting system comprises a cell, a quantum dot, a first bioactive ligand, a magnetic bead, a second bioactive ligand, a magnet, and a quantum dot measuring system. The cell endogenetically translates a first receptor and a second receptor and has a cell membrane, wherein the first receptor and the second receptor translocate to the cell membrane. The first bioactive ligand couples to the quantum dot, wherein the first bioactive ligand recognizes and couples to the first receptor. The second bioactive ligand couples to the magnetic bead, wherein the second bioactive ligand recognizes and couples to the second receptor. The magnet is configured for attracting the magnetic bead. The quantum dot measuring system includes an excitation light source, a detecting sensor, an optical system, and a data capturing unit. The excitation light source is configured for providing an exciting energy for the quantum dot to emit a fluorescence, wherein the quantum dot is excited in a pH range from pH 9 to pH 14. The detecting sensor is configured for detecting the fluorescence, wherein the detecting sensor comprises a photomultiplier tube converting the fluorescence into a signal. The optical system relays the fluorescence to the detecting sensor. The data capturing unit is electrically connected to the detecting sensor and capturing the signal.

The present invention also provides a detecting method comprising the following steps: providing an eukaryotic cell, having a cell nucleus and a cell membrane, wherein the cell nucleus endogenetically translates a first receptor and a second receptor, and wherein the first receptor and the second receptor pass through the cell nucleus and translocate to the cell membrane; coupling the first receptor to a first bioactive ligand with a quantum dot, wherein the first bioactive ligand has coupled with the quantum dot; washing the cell coupled with the first bioactive ligand and the quantum dot by centrifugation; coupling the second receptor to a second bioactive ligand with a magnetic bead, wherein the second bioactive ligand is coupled to the magnetic bead; washing the cell coupled with first bioactive ligand and the second bioactive ligand by magnetic separation; irradiating an exciting energy for the quantum dot to emit a fluorescence, wherein the quantum dot in the second unit is excited in a pH range from pH 9 to pH 14; and detecting the fluorescence.

The foregoing has outlined rather broadly the features and technical benefits of the disclosure in order that the detailed description of the invention that follows may be better understood. Additional features and benefits of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes of the disclosure. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become apparent upon reading the following description and upon reference to the accompanying drawings.

The foregoing aspects and many of the accompanying advantages of this invention will become more readily appreciated as the same becomes better understood by reference to the following detailed description, when taken in conjunction with the accompanying drawings, wherein:

FIG. 1 is a schematic view diagram illustrating a cell detecting system according one preferred embodiment of the present invention;

FIG. 2 is a schematic view diagram illustrating an embodiment of the present invention;

FIG. 3 is a schematic view diagram illustrating a quantum dot measuring system according to an embodiment of the present invention;

FIG. 4A is a schematic view of the experimental outcome of an embodiment of the present invention;

FIG. 4B is a schematic view of the experimental outcome of an embodiment of the present invention;

FIG. 5 is a schematic view of the experimental outcome of exciting the quantum dot in a pH range from pH 8 to pH 14 in accordance with an embodiment of the present invention; and

FIG. 6 is a schematic view of the experimental outcome of the exciting period of the quantum dot from pH 8 to pH 14 in accordance with an embodiment of the present invention.

### DETAILED DESCRIPTION

The present disclosure is directed to a cell detecting system and a detecting method thereof. In order to make the present disclosure completely comprehensible, detailed steps and structures are provided in the following description. Obviously, implementation of the present disclosure does not limit special details known by persons skilled in the art. In addition, known structures and steps are not described in details, so as not to limit the present disclosure unnecessarily. Preferred embodiments of the present disclosure will be described below in detail. However, in addition to the detailed description, the present disclosure may also be widely implemented in other embodiments. The scope of the present disclosure is not limited to the detailed description, and is defined by the claims.

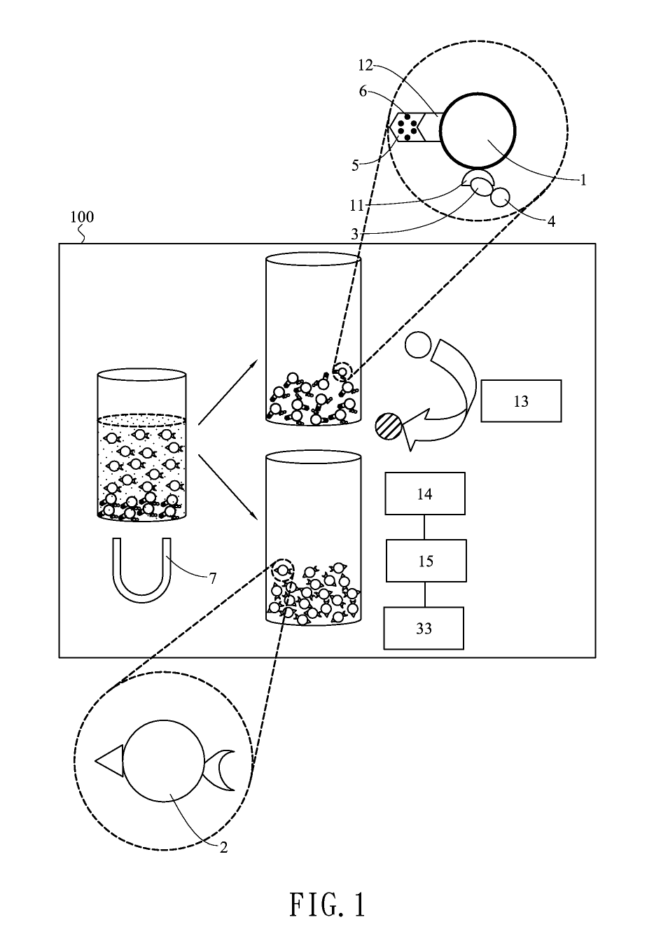

Referring to FIG. 1, a cell detecting system 100 according to an embodiment of the present invention is provided. The trapping and detecting theory is firstly disclosed. In this embodiment, an eukaryotic cell 1 includes a cell nucleus and a cell membrane, wherein the cell nucleus endogenetically translates a first receptor 11 and a second receptor 12. The first receptor 11 and the second receptor 12 endogenetically translated by the cell nucleus of the eukaryotic cell 1 pass through the cell nucleus and translocate to the cell membrane. A first bioactive ligand 3 is coupled to a quantum dot 4 and is capable of recognizing and coupling to the first receptor 11 of the specific cell 1; and a second bioactive ligand 5 is coupled to a magnetic bead 6 and is capable of recognizing and coupling to the second receptor 12 of the specific cell 1, wherein the diameter of the magnetic bead 6 is between 25 nm and 5000 nm.

With the above-mentioned coupling mechanism, a complex is formed with the specific cell 1, first bioactive ligand 3, quantum dot 4, second bioactive ligand 5 and magnetic bead 6 while a second cell 2 which is lack of the first receptor 11 and second receptor 12 is not recognized by and coupled to the first bioactive ligand 3 and second bioactive ligand 5 and it is thus unable to form such a complex. Therefore, the above-mentioned configuration achieves the goal of isolating cells. The complex with the magnetic bead 6 may be further attracted by a magnet 7 for cell trapping. In addition, the complex having quantum dot 4 which is of high fluorescence and stability may be applied for high-sensitivity detection.

The first bioactive ligand 3 and the second bioactive ligand 5 respectively comprise an antibody, a small molecule, a nucleotide, or a protein assembly. Here, the small molecule, for example, is a pentazocine, an anisamide, or a haloperidol coupling to a sigma receptor on the cell. A nucleotide, e.g. deoxyribonucleic acid (DNA) and ribonucleic acid (RNA), forms an aptomer which recognizes a specific receptor. In addition, the protein assembly includes a major histocompatibility complex and a peptide, and the protein assembly specifically recognizes a T cell receptor.

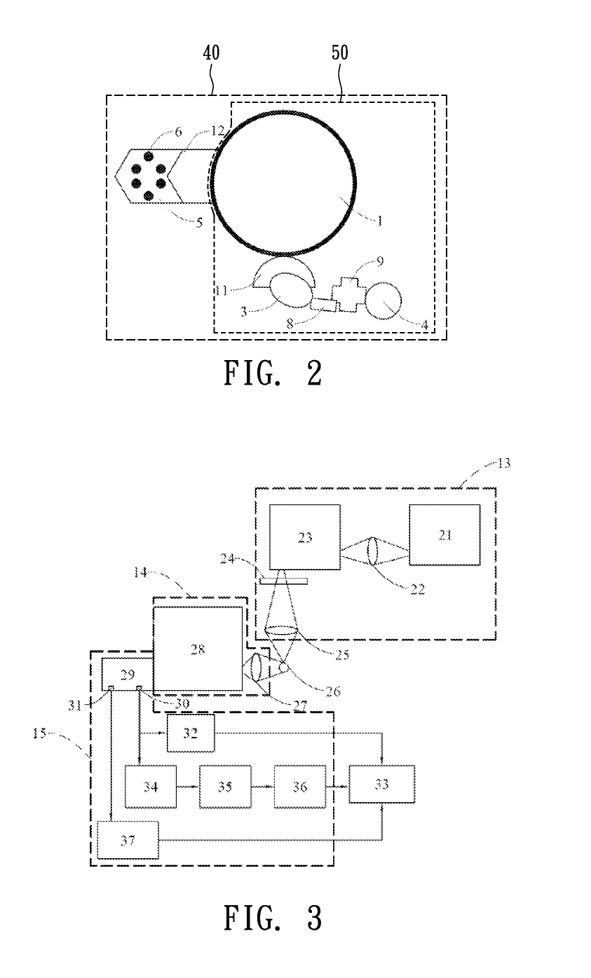

The coupling of the first bioactive ligand 3 to the quantum dot 4 and the second bioactive ligand 5 to the magnetic bead 6 may be direct or indirect. FIG. 2 illustrates an example in which the first bioactive ligand 3 is indirectly coupled to the quantum dot 4. For example, the first bioactive ligand 3 is indirectly coupled to the quantum dot 4 with a biotin 8 and a streptavidin 9. The coupling of the biotin 8 and streptavidin 9 is of high association constant (10¹⁴ M⁻¹) with four biotins coupling to a streptavidin and is commonly practiced in coupling between biological molecules. In the embodiment, the first receptor 11 of the cell 1 recognizes and couples with the first bioactive ligand 3, which is coupled with the quantum dot 4 to form a first unit 50. The first unit 50 can be washed to prevent non-specific binding or interaction. And then the second receptor 12 of the cell 1 recognizes and couples with second bioactive ligand 5, which is coupled with the magnetic bead 6 to form a second unit 40. The second unit 40 is composed of the first unit 50, the second receptor 12 of the cell 1, and the magnetic bead 6. By such design, the magnetic bead 6 won't be non-specifically interacted with the quantum dot 4.

In one example, the quantum dot 4 includes a PbS quantum dot, an II-VI quantum dot, or an III-V quantum dot. The II-VI quantum dot includes a CdSe quantum dot or a CdTe quantum dot, wherein the II-VI quantum dot may be encapsulated with a ZnS coating. The III-V quantum dot includes an InP quantum dot, a GaN quantum dot, or an InAs quantum dot encapsulated with a GaAs coating.

The fluorescence measuring system of the present invention is next described. Referring to FIG. 1, a quantum dot measuring system according to one preferred embodiment of the present invention includes an excitation light source 13, a detecting sensor 15, an optical system 14 and a data capturing unit 33. The excitation light source 13 is configured for providing an exciting energy for the quantum dot 4 of the complex to emit fluorescence, wherein the quantum dot 4 is excited in a pH range from pH 9 to pH 14. The optical system 14 relays the fluorescence to the detecting sensor 15 configured for detecting the fluorescence. The signal measured by the detecting sensor 15 is then transmitted to the data capturing unit 33 electrically connected to the detecting sensor 15 and capturing the signal. Here, the detecting sensor 15 includes a photomultiplier tube or a photodiode converting the fluorescence into a signal to improve the detection sensitivity of the quantum dot measuring system.

Refer to FIG. 1 and FIG. 3 for further detailed description, in which FIG. 3 illustrates a quantum dot measuring system according to an embodiment of the present invention. The excitation light source 13 including a light source 21, a first lens 22, a first monochromator 23, a spill shield 24 and a second lens 25 excites a cell sample 26 having the quantum dot. The example of light source 21 may include an ultraviolet light, a light-emitting diode, X-ray, synchrotron radiation light source, infrared ray or a laser light. The excitation light source 21 excites the quantum dot 4 in a time-period from 7 to 40 minutes. In addition, the pH value is between 9 and 14 in the measuring solution of the quantum dot measuring system.

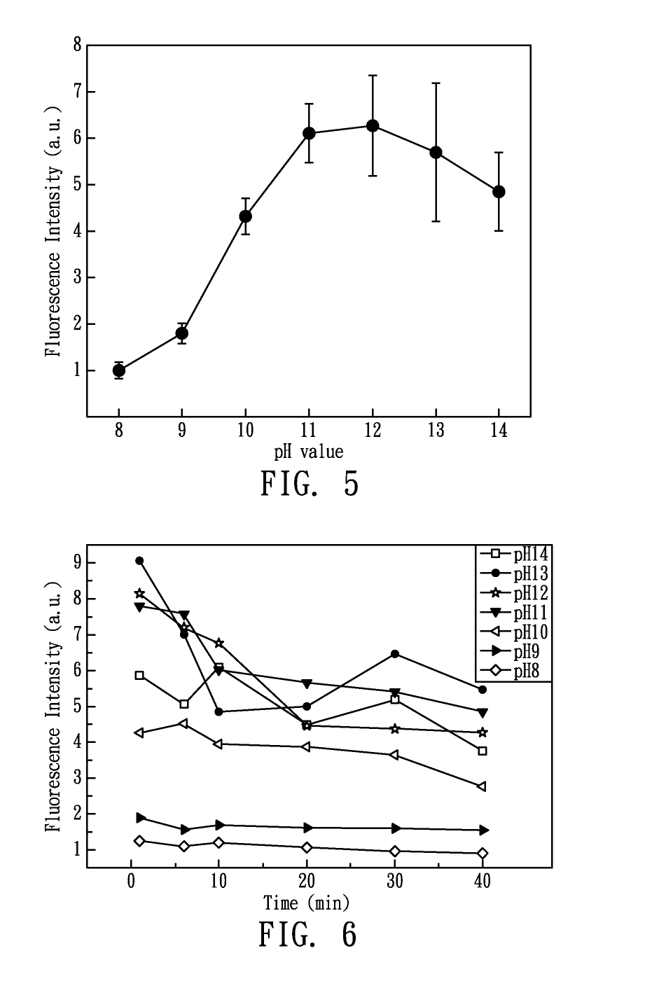

Referring to FIG. 5, the cell detecting system 100 is performed to continuously excite the quantum dot at ten minutes in different experimental groups with respective pH value. As shown in FIG. 5, exciting the quantum dot is well performed from pH 9 to pH 14, preferably from pH 10 to pH 13. Referring to FIG. 6, the cell detecting system of the quantum dot in the second unit is excited by excitation light source 13 to emit fluorescence, which is unstable at the initial 7 minutes under the excitation or irradiation of the light source 13. In other words, the fluorescence intensity will be relatively stable from 7 to 40 minutes, preferably from 10 to 20 minutes, after the fluorescence excitation is performed.

The excited fluorescence is relayed by the optical system 14 including a third lens 27 and a second monochromator 28 to the detecting sensor 15 which includes a photomultiplier tube 29. The example of 29 may include photomultiplier tube or a photodiode.

The signal measured by the photomultiplier tube 29 is further converted into a current signal or a pulse signal then captured by the data capturing unit 33. In one embodiment, the photomultiplier tube 29 includes a current mode 30 used for converting the signal measured by the photomultiplier tube 29 into a current signal, and the detecting sensor 15 further includes an ammeter 32 electrically connected to the current mode 30 and measuring the current signal. In another embodiment, in addition, the detecting sensor 15 further includes a lock-in amplifier 34, a voltage-to-frequency converter 35 and a frequency counter 36. Here, the lock-in amplifier 34 is electrically connected to the current mode 30 and converts the current signal into a voltage output; the voltage-to-frequency converter 35 is electrically connected to the lock-in amplifier 34 and converts the voltage generated by the lock-in amplifier 34 into frequency then output by the frequency counter 36 to the data capturing unit 33.

In another embodiment, the photomultiplier tube 29 includes a pulse mode 31 used for converting the signal measured by the photomultiplier tube 29 into a pulse signal. The pulse signal generated by the photomultiplier tube 29 is transmitted to the photon counter 37 which is electrically connected to the pulse mode 31 and output to the data capturing unit 33.

Furthermore, it is noted that the photomultiplier tube is cooled in a vacuumed or non-vacuumed way to lower the background current of the photomultiplier tube in one embodiment of the present invention, and the temperature of the photomultiplier tube is between −200° C. and 25° C.

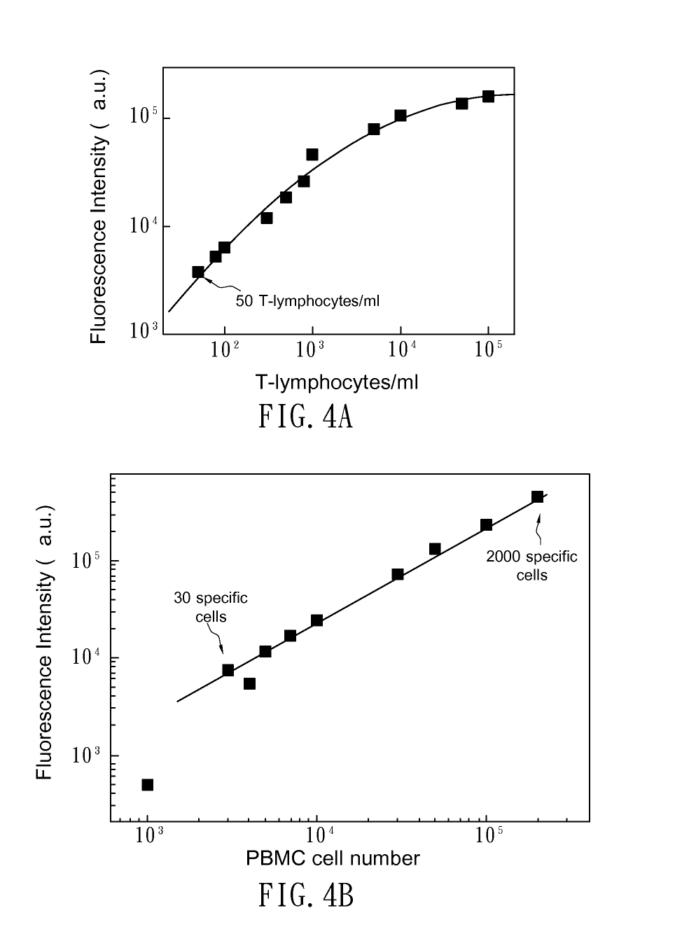

Referring to FIG. 2, in an embodiment, the specific cells 1 are human T-lymphocytes having a first receptor 11 and a second receptor 12, e.g. a CD3 or CD4 marker. Second cells 2, e.g. B-lymphocytes, having a CD19 or CD40 marker on their surfaces are mixed into the environment where the T-lymphocytes are incubated. In this embodiment, the T-lymphocytes and B-lymphocytes are well mixed. The first bioactive ligand 3, i.e. an anti-CD3 antibody, reacts with the CD3 on the T-lymphocytes and then couples to the quantum dot 4 by biotin 8 and streptavidin 9, and the T-lymphocytes are thus coupled with the quantum dot 4. The CD4 marker of the T-lymphocytes is then coupled to a second bioactive ligand 5, i.e. an anti-CD4 antibody, with a magnetic bead 6 to form a complex. Referring to FIG. 4A shows the experimental outcome according to this embodiment, the detection sensitivity of the experiment is, but not limited to, about 50 specific cells/ml in total of 10⁶ mixing cells/ml. In another embodiment, the T-lymphocytes and B-lymphocytes are well mixed. The first bioactive ligand 3, i.e. an anti-CD19 antibody, reacts with the CD19 on the B-lymphocytes and then couples to the quantum dot 4 by biotin 8 and streptavidin 9, and the B-lymphocytes are thus coupled with the quantum dot 4. The CD40 marker of the B-lymphocytes is then coupled to a second bioactive ligand 5, i.e. an anti-CD40 antibody, with a magnetic bead 6 to form a complex.

Another embodiment of the present invention includes a method for detecting the percentage of human PBMC (peripheral blood mononuclear cell) containing EB (Epstein-Barr) virus. In this embodiment, the first bioactive ligand includes a MHC (Major histocompatibility complex) bonded with a specific EB virus peptide (represented by SEQ ID NO:1) monomer for specifically recognizing T-cell receptor. The EB virus peptide specifically recognizes the first receptor of the EB virus specific T-cell, e.g. a T-cell receptor of EB virus containing cells. The MHC monomer couples to a biotin to form a MHC-peptide-biotin which further couples to a streptavidin with a quantum dot to form a multimer. A second receptor, e.g. a CD8 marker, on the PBMC cell surface is then coupled by a second bioactive ligand, i.e. an anti-CD8 antibody, with a magnetic bead to form a complex. The specific cells are isolated and then applied for quantum dot fluorescence measuring. FIG. 4B shows the experimental outcome of this embodiment. There is 1% EB virus containing cells and the detection limits is about 3000 PBMC, i.e. 30 EB virus containing cells. The sensitivity of the present embodiment is 0.003% and is much better than 0.01% for conventional flow cytometry sensitivity based on the presumption of 10⁶ cells/ml in the blood.

In addition, the present invention also provides a detecting method comprising the following steps: providing a cell, endogenetically translating a first receptor and a second receptor and having a cell membrane, wherein the first receptor and the second receptor translocate to the cell membrane; coupling the first bioactive ligand to a quantum dot, wherein the first bioactive ligand is coupled to the first receptor of the cell to form a first unit comprising the cell, the first bioactive ligand and the quantum dot; washing the cell in the first unit by centrifugation; coupling the second bioactive ligand to a magnetic bead, wherein the second bioactive ligand is coupled to the second receptor of the cell to form a second unit comprising the first unit, the second bioactive ligand and the magnetic bead; washing the cell in the second unit by magnetic separation; irradiating the exciting energy for the quantum dot to emit a fluorescence, wherein the quantum dot in second unit is excited in a pH range from pH 9 to pH 14 for 7 to 40 minutes; and analyzing the fluorescence. Since the first unit and the second unit of the cells are washed in separate steps and different ways, the cross-contamination and non-specific interaction between the first bioactive ligand and the second bioactive ligand can be avoided. Furthermore, since the quantum dot in second unit is excited from pH 9 to pH 14, the excited fluorescence intensity improves so as to have a better sensitivity. Moreover, after the quantum dot in second unit is excited from 7 to 40 minutes, the fluorescence is sensed or detected to be analyzed. In another embodiment (not shown), the detecting method further comprises a step of transfecting nucleotides including genetic sequences of the first receptor and the second receptor. After the nucleotides of the first receptor and the second receptor are transfected into the cell, the transcription and translation of the first receptor and the second receptor are enhanced. Thus, a lot of molecules of the first receptors and the second receptors are translocated to the cell membrane of the cell so as to couple the first bioactive ligand and the second bioactive ligand, respectively.

To sum up, a cell detecting method according to the present invention using a magnetic bead, a quantum dot and a quantum dot measuring system with a photomultiplier tube achieves the goal of specific cell detection with high sensitivity without performing cell culture.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

Sequence Listing

SEQUENCE LISTING

| | |
|---|---|
| (1) | GENERAL INFORMATION: |
| (iii) | NUMBER OF SEQUENCE: 1 |
| (2) | INFORMATION FOR SEQ ID NO: 1 |
| (i) | SEQUENCE 5 CHARACTERISTICS: |
| (A) | LENGTH: 10 amino acids |
| (B) | TYPE: amino acid |
| (C) | TOPOLOGY: linear |
| (ii) | MOLECULE TYPE: peptide |
| 10(xi) | SEQUENCE DESCRIPTION: SEQ ID NO: 1: |
| | Ser Ser Cys Ser Ser Cys Pro Leu Ser Lys |
| | 1 5 10 |

What is claimed is:

1. A detecting method, comprising steps of:
providing an eukaryotic cell, having a cell nucleus and a cell membrane, wherein the cell nucleus endogenetically translates a first receptor and a second receptor, and wherein the first receptor and the second receptor pass through the cell nucleus and translocate to the cell membrane;
coupling the first receptor to a first bioactive ligand with a quantum dot;
washing the cell coupled with the first bioactive ligand and the quantum dot by centrifugation;
coupling the second receptor to a second bioactive ligand with a magnetic bead;
washing the cell coupled with the first bioactive ligand and the second bioactive ligand by magnetic separation;
irradiating an exciting energy for the quantum dot to emit a fluorescence, wherein the quantum dot coupled with the cell is excited in a pH range from pH 9 to pH 14; and
detecting the fluorescence.

2. The detecting method as claimed in claim 1, wherein the first receptor is selected from a sigma receptor, a T cell receptor, a CD3 marker, a CD4 marker, a CD19 marker, a CD40 marker, and a CD8 marker.

3. The detecting method as claimed in claim 1, wherein the second receptor is selected from a sigma receptor, a T cell receptor, a CD3 marker, a CD4 marker, a CD19 marker, a CD40 marker, and a CD8 marker, and the second receptor is different from the first receptor.

4. The detecting method as claimed in claim 1, wherein the first bioactive ligand, in response to the first receptor, is selected from a pentazocine, an anisamide, a haloperidol, an antomer, a major histocompatibility complex (MHC) molecule, an anti-CD3 antibody, an anti-CD4 antibody, an anti-CD19 antibody, an anti-CD40 antibody, and an anti-CD8 antibody.

5. The detecting method as claimed in claim 1, wherein the second bioactive ligand, in response to the second receptor, is selected from a pentazocine, an anisamide, a haloperidol, an antomer, a major histocompatibility complex (MHC) molecule, an anti-CD3 antibody, an anti-CD4 antibody, an anti-CD19 antibody, an anti-CD40 antibody, and an anti-CD8 antibody.

6. The detecting method as claimed in claim 1, wherein the quantum dot comprises a PbS quantum dot, a II-VI quantum dot or a III-V quantum dot.

7. The detecting method as claimed in claim 6, wherein the II-VI quantum dot comprises a CdSe quantum dot or a CdTe quantum dot.

8. The detecting method as claimed in claim 6, wherein the II-VI quantum dot is encapsulated with a ZnS coating.

9. The detecting method as claimed in claim 6, wherein the III-V quantum dot comprises an InP quantum dot, a GaN quantum dot, or an InAs quantum dot encapsulated with a GaAs coating.

10. The detecting method as claimed in claim 1, wherein the quantum dot and the first bioactive ligand is coupled by a streptavidin and a biotin.

11. The detecting method as claimed in claim 1, wherein the magnetic bead and the second bioactive ligand are coupled through an interaction between a streptavidin and a biotin.

12. The detecting method as claimed in claim 1, wherein a first unit is composed of the cell, the first receptor, the first bioactive ligand, and the quantum dot and a second unit is composed of the first unit, the second receptor, the magnetic bead, and the second bioactive ligand, the second unit is irradiated in a pH value between pH 9 and pH 14.

13. The detecting method as claimed in claim 1, wherein the diameter of the magnetic bead is between 25 nm and 5000 nm.

14. The detecting method as claimed in claim 1, wherein the exciting energy is emitted from an excitation light source, the excitation light source is selected from an ultraviolet light, a light-emitting diode, X-ray, synchrotron radiation light source, infrared ray and a laser light, and the excitation light source excites the quantum dot in a time-period from 7 to 40 minutes.

15. The detecting method as claimed in claim 1, wherein the temperature for detecting the fluorescence by a photomultiplier tube is between −200 and 25° C.

16. The detecting method as claimed in claim 15, wherein the photomultiplier tube is cooled in a vacuumed or non-vacuumed way to lower the background current of the photomultiplier tube.

17. The detecting method as claimed in claim 15, wherein the photomultiplier tube comprises a pulse mode used for converting the fluorescence measured by the photomultiplier tube into a pulse signal.

18. The detecting method as claimed in claim 15, wherein the photomultiplier tube comprises a current mode used for converting the fluorescence measured by the photomultiplier tube into a current signal.

19. The detecting method as claimed in claim 1, further comprising a step of transfecting nucleotides including sequences of the first receptor and the second receptor.

20. The detecting method as claimed in claim 1, wherein after the quantum dot is excited from 7 to 40 minutes, the fluorescence is analyzed.
